(19) United States
(12) Patent Application Publication
(10) Pub. No.: US 2016/0330244 A1
(43) Pub. Date: Nov. 10, 2016

(54) Secure Storage of Data Among Multiple Devices

(71) Applicant: MAXWELL FOREST PTY LTD, Surry Hills (AU)

(72) Inventors: Matthew Charles Denton, Bronte (AU); Stephen Wilson, Five Dock (AU)

(21) Appl. No.: 15/109,939

(22) PCT Filed: Jan. 6, 2015
(86) PCT No.: PCT/AU2015/050001

§ 371 Date: Jul. 6, 2016

Related U.S. Application Data
(60) Provisional application No. 61/924,159, filed on Jan. 6, 2014.

(51) Int. Cl. H04L 29/06; G06F 21/62; G06F 17/30

(52) U.S. Cl. CPC H04L 63/20; G06F 17/30165; G06F 17/30194; G06F 21/6245

(57) ABSTRACT

Described herein is a computer implemented method for securely storing a record. Record storage criteria and record access criteria are received and the record is processed according to the record storage criteria and the record access criteria to generate a plurality of record shares from which the record can be recovered. The plurality of record shares are transmitted to the set of share storage devices, wherein at least one record share is transmitted to each share storage device in the set of share storage devices.

### CROSS-REFERENCE TO RELATED APPLICATIONS

This application claims the benefit of U.S. provisional application 61/924,159, filed on 6 Jan. 2014, which is incorporated by reference in its entirety.

### TECHNICAL FIELD

The embodiments described herein generally relate to systems and methods for securely storing data among multiple devices and for retrieving data so stored.

### DESCRIPTION OF THE RELATED ART

A need exists to be able to store data securely—i.e. so the owner of the data can control who has access to it.

A digital vault refers to a form of digital storage intended for safeguarding personal digital documents or data. Digital vaults can take various forms including cloud storage and storage on personal hardware devices such as hard disk drives or solid state drives.

Access control measures are implemented to prevent unauthorized access to the contents of a digital vault. Access control options include, for example, passwords, biometrics, and two factor authentication processes. Two factor authentication (also referred to as multi factor authentication) generally entails corroborating a user's electronic identity by requiring the user to prove knowledge of a secret (e.g., something only the user should know) as well as possession of a device such a key fob (something the user has). Proof of possession of a device in two factor authentication may be achieved, for example, by having a user enter a one-time code displayed by a key fob, in addition to entering a username and password when logging in.

Typically the contents of a digital vault are encrypted to provide an additional layer of security. Even if the access control on a vault is circumvented by an unauthorized person, they may be prevented from retrieving intelligible contents from the vault if the contents are encrypted. Encryption options include symmetric cyphers, asymmetric cyphers, stream cyphers, block cyphers and one time pads.

Reference to any prior art in this specification is not, and should not be taken as, an acknowledgment or any form of suggestion that this prior art would be known to a person of ordinary skill in the art.

### SUMMARY

Described herein is a computer implemented method for securely storing a record, the method comprising: receiving record storage criteria defining a set of share storage devices to be used to store shares of the record; receiving record access criteria defining requirements for recovering the record from share storage devices in the set of share storage devices, the record access criteria defining a minimum number of share storage devices that are required in order to recover the record; processing the record according to the record storage criteria and the record access criteria to generate a plurality of record shares from which the record can be recovered; and transmitting the plurality of record shares to the set of share storage devices, wherein at least one record share is transmitted to each share storage device in the set of share storage devices.

Also described herein is a computer processing system for securely storing a record, the system comprising: a processor; a communications interface for communicating with a plurality of share storage devices; non-transient memory storing instructions which, when executed by the processor, cause the system to: receive record storage criteria defining a set of share storage devices to be used to store shares of the record; receive record access criteria defining requirements for recovering the record from share storage devices in the set of share storage devices, the record access criteria defining a minimum number of share storage devices that are required in order to recover the record; process the record according to the record storage criteria and the record access criteria to generate a plurality of record shares from which the record can be recovered; and transmit, via the communications interface, the plurality of record shares to the set of share storage devices, wherein at least one record share is transmitted to each share storage device in the set of share storage devices.

The features and advantages described herein are not all-inclusive. Many additional features and advantages will be apparent to one of ordinary skill in the art in view of the drawings, specification, and claims.

### BRIEF DESCRIPTION OF THE DRAWINGS

FIG. 1 is a schematic block diagram of illustrating a set of devices operating in accordance with an embodiment.

FIG. 2 is a block diagram of a computer processing device suitable for use as a vault controller device.

FIG. 3 is a block diagram of an electronic device suitable for use as a share storage device.

FIG. 4 is a flow chart illustrating steps performed by a vault controller device to securely store a record in accordance with an embodiment.

FIG. 5 is a flow chart illustrating steps performed by the vault controller device 102 in recovering a securely stored record in accordance with an embodiment.

FIG. 6 depicts a record storage example according to an embodiment.

FIG. 7 depicts a record recovery example according to an embodiment.

FIGS. 8 and 9 depict an example implementation for securely storing, recovering, and submitting a CVV in accordance with an embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

### Overview

Generally speaking, embodiments relate to systems and methods for securely storing records in a digital vault. In the context of the present specification, the digital vault is a distributed vault involving multiple physical devices among which data relating to the record (and, provided certain conditions are met, allowing recovery of the record) is distributed. The digital vault may also be referred to as a vault, a secret sharing vault, a secure storage vault, or a distributed storage vault.

While the described embodiments refer to “storage” of a record, it will become apparent that it is not the record per se that is stored, but rather shares or components of data which are calculated based on the record and which, when properly combined, allow the original record to be recovered or calculated.

Described embodiments implement multi factor authentication using a plurality of share storage devices which also serve as the storage medium for the vault itself. Further the described embodiments improve upon “M-of-N” access control where, in one embodiment, a set of N devices are registered with an access control mechanism and only a subset M of the N devices are needed in order to access a stored item.

Described embodiments provide differential storage and access control in which the relative difficulty of gaining access to different records in a digital vault is configurable according to the sensitivity or value to the user of each record concerned.

Differential storage and access control is provided by a vault control program running on a vault controller device. The vault control program generates shares of a record to be stored and distributes those shares among a set of N share storage devices. The vault controller device may itself act as a share storage device and store one or more of the record shares. In one embodiment the number of shares generated for a given record is the same as the number of share storage devices which are to be used to securely store that record, and each share storage device receives a single share.

In order to securely store a record in a digital vault, record storage and access criteria are defined. The record storage and access criteria generally define the devices that will participate in storing the record, the number of devices necessary to recover the record, and any additional security conditions for recovery of the record.

Based on the record storage and access criteria the vault controller generates a number of record shares using a secret algorithm and the shares are distributed among the set of share storage devices.

Various access criteria for each individual record stored by the vault may be configured by the user. Access criteria may, for example, be defined in terms of specific share storage devices that need to be activated in order to recover the record in question. Record access criteria may also define additional security conditions that must be met in order for a given record share to be recovered from a given device.

The described embodiments enable users to understand and personally take control of the balance that must often be struck between convenience and security. Some records might not be so valuable and may be secured in a way that the record can be easily and quickly recovered (e.g. by means of a tablet computer plus a cell phone). Other records might be more valuable and the user is therefore prepared to have to exercise more devices in a less convenient manner in order to recover the record (e.g. involving multiple devices one or more of which could optionally be entrusted to trusted third parties).

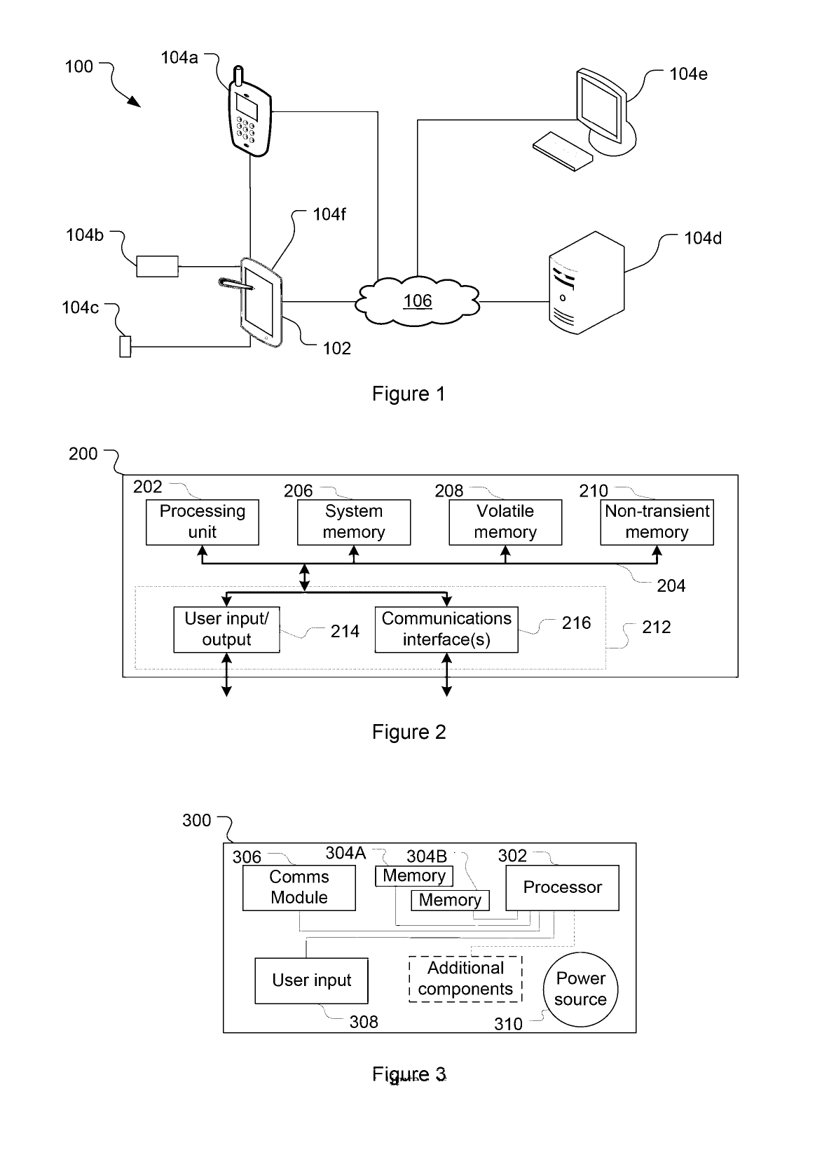

FIG. 1 is a schematic block diagram of illustrating a set of devices 100 operating in accordance with an embodiment.

The set of devices 100 includes a vault controller device 102. Vault controller device 102 is illustrated as being a portable computing device (in this case a tablet).

Vault controller device 102 communicates with a plurality of share storage devices 104. In FIG. 1 the share storage devices include a mobile/smart phone 104a, a smart card device 104b, a fob device 104c, a computer server 104d, and a personal computer 104e. The vault controller device 102 may itself be a share storage device (as indicated by reference numeral 104f) though need not be.

In operation, the vault controller device 102 receives a record to be securely stored, generates a number of record shares in respect of the record, and communicates those record shares to share storage devices 104. When the record is to be recovered the vault controller device 102 sends requests to the relevant share storage devices 104 to transmit the relevant record shares back to the vault controller device 102. On receiving the necessary record shares the vault controller device 102 recovers the record.

A share storage device 104 receives shares from the vault controller device 102 and stores those shares in non-transient memory. On a request being made from the vault controller device 102 (and any necessary conditions being satisfied) the share storage device 104 transmits the share back to the vault controller device 102.

Transmission of data between the vault controller device 102 and a given share storage device 104 depends on the nature of the share storage device 104 in question. For example, the smart card device 104b, and fob device 104c are depicted as communicating directly with the vault controller device 102. Such direct communication may, for example, be by Bluetooth, infrared, or other wired or wireless direct communication technologies. In contrast, the server 104d and personal computer 104e are depicted as communicating with the vault controller device 102 over a telecommunications network 106. Network 106 may, for example, be a public network (e.g. the Internet), a local area network, a mobile phone network, or a combination of networks. Some share storage devices 104 may be capable of communicating with the vault controller device either directly or via a network 106. The mobile/smart phone device 104a is illustrated as such a device. Providing different communication channels between the vault controller device 102 and share storage devices 104 enhances security as it prevents a person listening on a single compromised channel from being able to intercept all record shares.

The set of devices 100 shown in FIG. 1 are by way of example only and it will be appreciated that alternative types of vault controller device 102 and/or share storage devices 104 are possible. Furthermore, depending on the level of security required fewer or additional devices of the same or different types may be used.

Vault Controller Device

Generally speaking, a vault controller device 102 may be any computer processing system capable of running a vault control program (described below) and communicating with share storage devices. FIG. 2 provides a block diagram of one type of computer processing system 200 suitable for use/configuration as a vault controller device 102.

Computer processing system 200 comprises a processing unit 202. The processing unit 202 may comprise a single computer-processing device (e.g. a central processing unit, graphics processing unit, or other computational device), or may comprise a plurality of computer processing devices. In some instances processing is performed solely by processing unit 202, however in other instances processing may also, or alternatively, be performed by remote processing devices accessible and useable (either in a shared or dedicated manner) by the computer processing system 200.

Through a communications bus 204 the processing unit 202 is in data communication with one or more machine-readable storage (memory) devices that store instructions and/or data for controlling operation of the computer processing system 200. In this instance computer processing system 200 comprises a system memory 206 (e.g. a BIOS or flash memory), volatile memory 208 (e.g. random access memory such as one or more DRAM modules), and non-volatile/non-transient memory 210 (e.g. one or more hard disk or solid state drives).

Computer processing system 200 also comprises one or more interfaces, indicated generally by 212, via which the computer processing system 200 system 200 interfaces with various components, other devices and/or networks. Other components/devices may be physically integrated with the computer processing system 200, or may be physically separate. Where such devices are physically separate connection with the computer processing system 200 may be via wired or wireless hardware and communication protocols, and may be direct or indirect (e.g. networked) connections.

Wired connection with other devices/networks may be by any standard or proprietary hardware and connectivity protocols. For example, the computer processing system 200 may be configured for wired connection with other devices/communications networks by one or more of: USB; FireWire; eSATA; Thunderbolt; Ethernet; Parallel; Serial; HDMI; DVI; VGA; AudioPort. Other wired connections are possible.

Wireless connection with other devices/networks may similarly be by any standard or proprietary hardware and communications protocols. For example, the computer processing system 200 system 100 may be configured for wireless connection with other devices/communications networks using one or more of: infrared; Bluetooth (including early versions of Bluetooth, Bluetooth 4.0/4.1/4.2 (also known as Bluetooth low energy) and future Bluetooth versions); Wi-Fi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are possible.

Generally speaking, the devices to which computer processing system 200 connects —whether by wired or wireless means—allow data to be input into/received by computer processing system 200 for processing by the processing unit 202, and data to be output by computer processing system 200. Example devices are described below, however it will be appreciated that not all computer processing systems will comprise all mentioned devices, and that additional and alternative devices to those mentioned may well be used.

For example, computer processing system 200 may comprise or connect to one or more input devices by which information/data is input into (received by) the computer processing system 200. Such input devices may comprise physical buttons, alphanumeric input devices (e.g. keyboards), pointing devices (e.g. mice, track-pads and the like), touchscreens, touchscreen displays, microphones, accelerometers, proximity sensors, GPS devices and the like. Computer processing system 200 may also comprise or connect to one or more output devices controlled by computer processing system 200 to output information. Such output devices may comprise devices such as indicators (e.g. LED, LCD or other lights), displays (e.g. LCD displays, LED displays, plasma displays, touch screen displays), audio output devices such as speakers, vibration modules, and other output devices. Computer processing system 200 may also comprise or connect to devices capable of being both input and output devices, for example memory devices (hard drives, solid state drives, disk drives, compact flash cards, SD cards and the like) which computer processing system 200 can read data from and/or write data to, and touch-screen displays which can both display (output) data and receive touch signals (input).

Computer processing system 200 may also connect to communications networks (e.g. the Internet, a local area network, a wide area network, a personal hotspot etc.) to communicate data to and receive data from networked devices, which may be other computer processing systems.

The architecture depicted in FIG. 2 may be implemented in a variety of computer processing systems, for example a laptop computer, a netbook computer, a tablet computer, a smart phone, a desktop computer, a server computer. It will also be appreciated that FIG. 2 does not illustrate all functional or physical components of a computer processing system. For example, no power supply or power supply interface has been depicted, however computer processing system 200 will carry a power supply (e.g. a battery) and/or be connectable to a power supply. It will further be appreciated that the particular type of computer processing system will determine the appropriate hardware and architecture, and alternative computer processing systems may have additional, alternative, or fewer components than those depicted, combine two or more components, and/or have a different configuration or arrangement of components.

Operation of the computer processing system 200 is also caused by one or more computer program modules which configure computer processing system 200 to receive, process, and output data. One such computer program module will be an operating system such as (by way of non-limiting example) Apple iOS or Android.

In addition, the vault controller device 102 stores and executes a vault controller program which causes the device 102 to perform the processes/operations described herein. The vault controller program (and other computer program modules) typically comprise instructions and data which are stored in non-transient memory (such as 210), loaded into volatile memory (such as 208), and executed by a processing unit (such as 202). Computer program modules may alternatively be implemented in hardware, firmware, or in a combination of software, hardware and/or firmware.

Share Storage Devices

Generally speaking, a share storage device 104 may be any electronic device capable of receiving, storing, and transmitting data.

Given the functionality required of a vault controller device 102, a vault controller device (e.g. a computer processing system 200 as described above) will be capable of operating as a share storage device. The reverse is not, however, necessary. For example, a share storage device may be a simple storage device with communication capabilities but without the capabilities required to operate as a vault controller device.

FIG. 3 provides a block diagram of one example of a “simple” share storage device 300 (i.e. a device capable of being s share storage device 104 but without more sophisticated computer processing capabilities). Share storage device 300 may be a small form factor device such as a credit card, fob or the like though could also be a larger form factor device.

Device 300 comprises a processor 302, memory 304 for storing instructions executable by the processor 302 and data, and a wireless communication module 306 for enabling wireless communications with (i.e. sending messages to and receiving messages from) other devices.

By way of example, the processor 302, memory 304 (which comprises both non-transient memory 304A such as flash memory and volatile memory 304B such as RAM), and communication module 306 are provided in an integrated microcontroller unit (MCU) such as the CC61441 or CC61440 manufactured by Texas Instruments. The communication module in this case is a Bluetooth wireless communications module compliant with Bluetooth version 4.0/4.1 (also referred to as Bluetooth Low Energy (BTLE)).

Device 300 further comprises a user input 308 operable by a user to interact with the device 300. The user input 308 may be a simple push-button input which, on activation by a user, sends a signal to the processor 302. Depending on the context/state of the device 300 this signal may cause the processor to perform different actions—for example to authenticate the device 300 to another device and/or to cause the processor to perform an action such as transmitting a record share stored in memory 304A (e.g. via Bluetooth).

Device 300 also comprises a power source 310. The power source 310 is connected to and powers those components the device 300 that require power (connections not indicated in FIG. 3 for clarity)—for example, the MCU (i.e. the processor 302, memory 304, and communications module 306). In one embodiment power source 310 is a battery, such as a LiMn battery (for example manufactured by FDK).

Device 300 may include a variety of additional components providing additional functionality. For example, device 300 may include a force sensor 312 for sensing forces (e.g. impact, pressure, compression, twisting/bending and the like) or the result of forces (e.g. acceleration) and outputting force signals in response thereto. A force sensor such as the ADXL362 accelerometer manufactured by Analog Devices may be used. Alternatively a piezoelectric force sensor may be used. Device 300 may also/alternatively include outputs such as a light output or a speaker. Device 300 may be a payment card—e.g. a bank card, Visa card, MasterCard, American Express card or the like. In this case the device 300 further comprises components enabling the device 300 to be used as a payment card—e.g. a magnetic stripe with relevant encoded data and/or an EMV chip (EMV contact, contactless with antenna, or dual mode contact/contactless with antenna).

Device 300 is configured for operation by one or more computer program modules. A computer program module may be a software module comprising computer readable instructions (and potentially data) stored in non-transient memory such as 304A. In order for the relevant functionality to be performed, a software module is typically loaded into transient memory such as 304B and executed by the processor 302. Computer program modules may alternatively be implemented in hardware, firmware, or in a combination of software, hardware and/or firmware.

Device 300 is provided with at least a share storage program enabling the device 300 to: receive record shares from a vault controller device 102; store received record shares on non-transient memory 304A; receive requests for specific record shares from the vault controller device 102; and, in response to a request for a particular record share from the vault controller device 102, access that record share and communicate the share back to the vault controller device 102.

Depending on the hardware configuration of a share storage device 104, the share storage program may facilitate additional functionality. For example, if the share storage device has an input 308, the share storage program may define that a given record share will only be accessed and communicated back to the vault controller device if the input is activated. If the share storage device has an input allowing for letters or numbers to be entered (e.g. a keyboard or touchscreen), the share storage program may define that a given record share will only be accessed and communicated back to the vault controller device if a correct passcode (e.g. a password, PIN, or other code) is entered. The share storage device 104 may be configured to only communicate shares with a device it has previously enrolled with and which has been authenticated (e.g. via a paring/bonding type process). As a further example, if the share storage device has a force sensor, the share storage program may define that a given record share will only be accessed and communicated back to the vault controller device if a particular signal is generated by the force sensor (e.g. a signal representative of a tap or other gesture made with or on the device 104). The share storage program may also facilitate authentication of the share storage device with another device in an initial enrolment process and/or subsequent authentication process. For example where Bluetooth communications are used the share storage program may facilitate Bluetooth pairing and bonding with another device.

Share storage devices 104 may be dedicated devices which are sold preconfigured (by software and/or hardware) with the share storage program. Alternatively, share storage devices 104 may be generic devices with capable hardware, in which case the share storage program may be a software program transmitted to/received by the small form factor device 100 via a data signal in a transmission channel enabled (for example) by communications module 306.

Alternative Devices

As will be appreciated, many different types of devices may be suitable for use as a vault controller device 102 and/or a share storage device 104. A vault controller device 102 may have an architecture similar to computer processing system 200 described above or may have an alternative architecture. Similarly, a share storage device 104 may have an architecture similar to device 300 described above or may an alternative architecture.

Appropriate devices may include, for example, personal portable devices (e.g., tablet computers, cell phones, smart cards, a key fobs, USB devices and other forms of smart devices), personal computers, servers. The term “smart device” or “personal computer” can include many alternative form factors and embedded computing technologies in for example what is commonly known as the “Internet of Things.” The described embodiments can be implemented using a personal computer, a cell phone and one or more smart cards, yet the described embodiments may also be realized using a variety of less conventional devices which nevertheless have embedded computing capabilities such as: RFID tags, remote computers (e.g., cloud storage devices in the “cloud”); USB thumb drives; e-book readers; television sets; cable TV set-top boxes; portable media players; smart watches; smart bands; wearable computers; exercise equipment; physiological monitors; medical implants; medical monitoring devices; game consoles; modules contained in a vehicle; navigation devices; musical instruments.

Record Storage and Access

In order to securely store a given record in the digital vault a user interacts with the vault controller device 102 as configured by/running the a vault controller program. Using the vault controller device 102 the user submits a record for storage and defines record storage and access criteria for that record. The record storage criteria define the share storage devices 104 that will be used to store record shares. Record access criteria define the conditions under which the record can be recovered.

One example of a simple user interface allowing a user to define record storage and access criteria (and to store that information for future use) is a table interface which will be described below.

In the table interface embodiment the digital vault controller maintains a table storing information on the records stored by the vault and the relevant storage and access criteria. For each record in the digital vault, the table provides a row. For each share storage device 104 available to be used (in this example a phone, card, and FOB) the table provides a column. In order to store a record the user selects which share storage devices will share a record by ticking a box or providing a comparable computer user interface indication at the intersections of the record row and device columns.

The columns of the table are also used to define access criteria for recovering that record. For example, a table column (column ‘M’) below stores a user's indication of how many of the share storage devices will be required to recover the record.

For example, in Table 1 below the “credit card 1” record is shared between the phone and the smart card share storage devices 104. As indicated by the entry in column ‘M’, the “credit card 1” record may be recovered by presenting either one of the two devices (providing convenience to the user). The “credit card 2” record, however, is shared between the phone and the smart card storage devices 104 and requires both devices to be present in order to recover the record. Credit card information may include one or more of the following: card holder's name, a credit card number, an expiration date, a verification code of the credit card (as discussed below), and a billing address. On the other hand, the “loan documents” record is stored among the phone, the smart card, and the fob share storage devices 104, and all three share storage devices 104 are needed to recover the record.

TABLE 1

| RECORD | PHONE | CARD | FOB | M |
|---|---|---|---|---|
| Credit Card 1 | ✓ | ✓ | | 1 |
| Credit Card 2 | ✓ | ✓ | | 2 |
| Bank Account Number | ✓ | ✓ | ✓ | 2 |
| Loan Documents | ✓ | ✓ | ✓ | 3 |
| Resume | ✓ | | | 1 |
| Will | ✓ | ✓ | ✓ | 2 |
| Driver License | ✓ | | ✓ | 2 |
| Virtual currency | ✓ | ✓ | ✓ | 3 |
| Login User Name | ✓ | ✓ | ✓ | |
| Login Password | ✓ | ✓ | ✓ | 3 |

Record storage and access criteria may also define as a security condition that one or more specific share storage devices must be present/activated in order to recover a record. For example, in addition to a user indicating a number of share storage devices that will be used to store shares of a record and the number of devices required to recover the record, the user may also require one or more specific devices to be present/activated in order to recover the record. This is illustrated in Table 2 below, with a visual indicator (in this case an asterisk) being used to indicate any share storage devices that are necessary for recovery of a record. For example, in Table 2 the record access criteria in respect of the “will” record define that: the record will be stored among the phone, the card, and the FOB; at least two of the share storage devices 104 need to be present in order to recover the record; and the card share storage device must be present in order to recover the record. Under these record access criteria the user is not able to recover the record with the phone and the FOB (as the card is not present), is not able to recover the record with the card alone (as at least two devices are required), but would be able to recover the record with the card and the phone or the card and the FOB.

TABLE 2

| RECORD | PHONE | CARD | FOB | M |
|---|---|---|---|---|
| Will | ✓ | ✓ * | ✓ | 2 |

Additional security conditions may be imposed. For example, in configuration Table 3 below a requirement can be set that certain share storage devices must be tethered as a security condition of recovery. In Table 3 below this is indicated by grey shading of pairs of intersections. For example, in Table 3 the record access criteria in respect of the loan documents record define that: the record will be stored among three devices (the phone, card, and fob); all three devices are required in order to recover the record; and the phone and the card must be tethered to one another in order to recover the record

TABLE 3

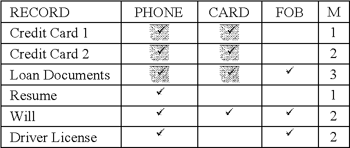

Tethering between two share storage devices 104 may be, for example, establishing a communication channel between the two devices (e.g., via Bluetooth). The vault controller program has conditions built into it relating to the availability of tethering potential (e.g. via RF or other connections) so that the user interface will only allow tethering connections that are sensible.

In some embodiments, the number of share storage devices M needed to be presented in order to recover the record may be logically pre-determined by other conditions such as the tethering that is specified, or by the fact that only one device is selected and so the value of M in that case cannot be different from one.

The configuration table may further allow the user to specify an additional security condition that a given share storage device 104 must be at a specified location or must be in range of a specified location before a record in the vault can be recovered. This is an example of a device specific security condition, in that it attaches to a particular share storage device 104. Geolocation and “geofencing” may be based upon signals relating to such fixed installations as a Home Wi-Fi network, an Office Wi-Fi network, or a cell phone network region (e.g., in country, international) that the share storage device 104 connects to. Location of a share storage device 104 may also/alternatively be defined by a position sensor such as a GPS operating on the share storage device 104 or on a device which the share storage device is proximate/connected to.

Table 4 below depicts use of the configuration table to specify a location security condition. In this example an additional column is added for any share storage device 104 that has a location condition active, the column defining location requirements. In Table 4 a location column is only shown for the Phone share storage device, but location columns could equally be provided for the card, FOB, or ID card devices. In Table 4, the record access criteria in respect of the professional license record define that: the record will be stored among two devices (the phone and ID card); both devices are required in order to recover the record; and the phone must be in the office in order to recover the record.

TABLE 4

| | | Phone | | | ID | |
|---|---|---|---|---|---|---|
| RECORD | PHONE | Location | CARD | FOB | CARD | M |
| Credit Card 1 | ✓ | In country | ✓ | | | 2 |
| Credit Card 2 | ✓ | Anywhere | ✓ | | | 1 |
| Loan Documents | ✓ | Home | ✓ | ✓ | | 3 |
| Resume | ✓ | | | | | 1 |
| Professional License | ✓ | Office | | | ✓ | 2 |
| Will | ✓ | | ✓ | ✓ | | 2 |
| Driver License | ✓ | | | ✓ | | 1 |

Additional security conditions that may be defined include time of day or, more generally, recovery time conditions. A recovery time condition for a given record may define that the record can only be accessed at one or more defined times, between one or more defined time ranges, before a defined time, and/or after a defined time. For example, security conditions may be set that a given record can only be accessed: between defined times on any day (e.g. between 9 AM and 5 PM on any day); between defined times on a particular day (e.g. between 2 PM and 4 PM on any Saturday); between defined times on one or more defined days (e.g. between 9 AM and 10 AM on 1 Jan. 2020); before a defined time (e.g. any time before 12:00 AM on 1 Jan. 2016); after a defined time (e.g. any time after 12:00 AM on 1 Jan. 2016). Continuing with the configuration table example, this could be provided, for example, by an additional “time restriction” column associated with a share storage device and storing data defining the time restriction.

As an example scenario, an access time condition may be set such that a particular record only becomes accessible after a person reaches a certain age. In this case the record may define data that provides access to a gift or inheritance or the like—e.g. by defining bank account details, bank account access codes, physical vault/safe access codes, location information and/or other access data. The access time condition can be used to restrict access to the record until the intended beneficiary of the account reaches a set age (e.g. on their 21^{st} birthday).

An additional security condition defined by the record access criteria may be that a particular gesture needs to be made with a share storage device 104 in order to recover the share. Accelerometer (or other force/motion sensing) technology integrated within a share storage device may be used to detect pre-defined gestures such tapping a card onto a hard surface, bumping two smart devices together, rotating a device through some trajectory (e.g. to mimic the action of turning a key in a lock); using the device to trace a particular pattern through the air (e.g. a circle); tapping the device on a surface one or more times; shaking the device one or more times.

As shown in Table 5 below, the configuration table is expanded to include “gesture” columns allowing the user to specify as a security condition a gesture that is required to activate a given share storage device for share (and hence record) recovery. In Table 5, the record access criteria in respect of the “credit card 2” record define that: the record will be stored among two devices (the phone and card); both devices are required in order to recover the record; and a tap gesture must be made with the card in order to recover the record.

TABLE 5

| | | | Card | | | |
|---|---|---|---|---|---|---|
| RECORD | PHONE | CARD | gesture | FOB | FOB gesture | M |
| Credit Card 1 | ✓ | ✓ | | | | 1 |
| Credit Card 2 | ✓ | ✓ | Tap | | Tap 3 times | 2 |
| Loan Documents | ✓ | ✓ | | ✓ | | 3 |
| Resume | ✓ | | | | | 1 |
| Will | ✓ | ✓ | | ✓ | Wave in a | 2 |
| | | | | | circle | |
| Driver License | ✓ | | | ✓ | Turn as key | 2 |

In a similar fashion to requiring a gesture by a share storage device, security conditions may require other actions to be taken with respect to a share storage device. For example, where a share storage device has a user control a security condition for recovery of a record may be activation of that control. Where a share storage device has richer input mechanisms (e.g. keyboard, touchscreen or the like), a security condition may be entry of a passcode.

Further a record may be shared amongst share storage devices 104 (e.g. remote or cloud devices) where not all share storage devices 104 are under the control of the user and (optionally) with access criteria defining that a share or shares stored by share storage device(s) not in control of the user are required in order to recover the record. This feature may be beneficial, for example, for securing digital documents in escrow where a trusted third party such as a lawyer has control of a share storage device that is necessary in order to recover the record. Or this feature may be beneficial if ownership of the record in question is shared by multiple parties as is the case with medical records owned jointly by a patient, a doctor and/or a medical institution. In this case the access criteria may allow for any of the patient/doctor/medical institution to access the record alone, or require two or even all three of the entities to provide their shares in order for the record to be accessed. A smart card or other share storage device may be entrusted to an attorney (see 3rd Party Card 1 in Table 6 below), and/or a remote or cloud sever maintained by the third party may be used as the share storage device. For another example, a pharmaceutical prescription could be shared across two share storage devices controlled by the user and additionally a card or other share storage device entrusted to a medical professional (see 3^{rd} Party Card 2 in Table 6 below). As a further example, the storage and access criteria for a credit card verification code may define that a share storage device in control of the card issuer (e.g. a remote server maintained by the card issuer accessible over communications networks) receives one or more shares of the record, and that the share(s) of the card issuer are required in order to recover the record. This scenario provides the card issuing with some control over use of the credit card, insofar as if the issuer wishes to prevent use of the card by a channel requiring the card verification value to be accessed from the secure vault it can delete its share(s) of the record or otherwise make the share(s) inaccessible.

TABLE 6

| | | | 3^{rd} Party | 3^{rd} Party | Card Issuing |
|---|---|---|---|---|---|
| RECORD | PHONE | CARD | Card 1 | Card 2 | Bank |
| Will | ✓ | ✓ | ✓ | | |
| Medical record | ✓ | | | ✓ | |
| Card | ✓ | ✓ | | | ✓* |
| verification | | | | | |
| value | | | | | |

It will be appreciated that additional security conditions to those described above may also be implemented. It will also be appreciated that the conditions described above may be combined. For example, a user may specify for a given record that two of the devices must be tethered, a device must be in a particular location, a particular gesture must be made with a device, and that the record can only be accessed at a defined time.

Embodiments may be used to secure digital documents in transit by sharing the data amongst a main storage device, a smart card issued to the recipient, and a smart card issued to a courier. The main storage device would be carried to the recipient by the courier. The recipient's smart card would be transmitted to the recipient through a different channel, such as by mail. To recover the contents of the main storage device, all three share devices would be activated at the recipient's location. Additional conditions such as geolocation of the recipient and time of day requirements would add further security as desired.

Embodiments may also be used to enable digital rights management mechanisms for controlling access to digital content such as movies. For example, a digital content owner can post shares of a content item on a cloud computer and distribute other shares on smart cards (or other share storage devices) issued to legitimate subscribers. A legitimate subscriber needs to present their smart card to a reader device to access and recover the content item as a whole from the cloud. If the content is shared across one cloud device and P smart cards and the secret sharing algorithm is configured as “2 of (P plus 1)” then the content is accessible by any one of the P smart card recipients.

It should be noted that the present embodiments do not remove the need for users to prepare diligently in the event of a disaster that destroys and renders inoperable a number of share devices such that the condition M can no longer be met. If M of N shares cannot be accessed after sharing, then the original data is fundamentally irrecoverable. Thus, a copy of a record may be stored as a backup before sharing.

Securely Storing a Record

Below are steps of a process for storing a record in the vault according to one embodiment. Those of skill in the art will recognize that other embodiments can perform the steps below in different orders. Moreover, other embodiments can include different and/or additional steps than the ones described below.

Initially, a vault controller device 102 is configured to provide the functionality described below. This may, for example, be by loading the vault controller application or program onto an appropriate vault controller device 102.

Similarly, share storage devices 104 (e.g., smart cards, key fobs, portable computers and the like) that are to be used to store records are loaded with software or firmware (e.g., a mobile application) for executing the steps described below.

The vault controller device 102 and/or share storage devices 104 may come preconfigured for participation in the record storage and retrieval processes.

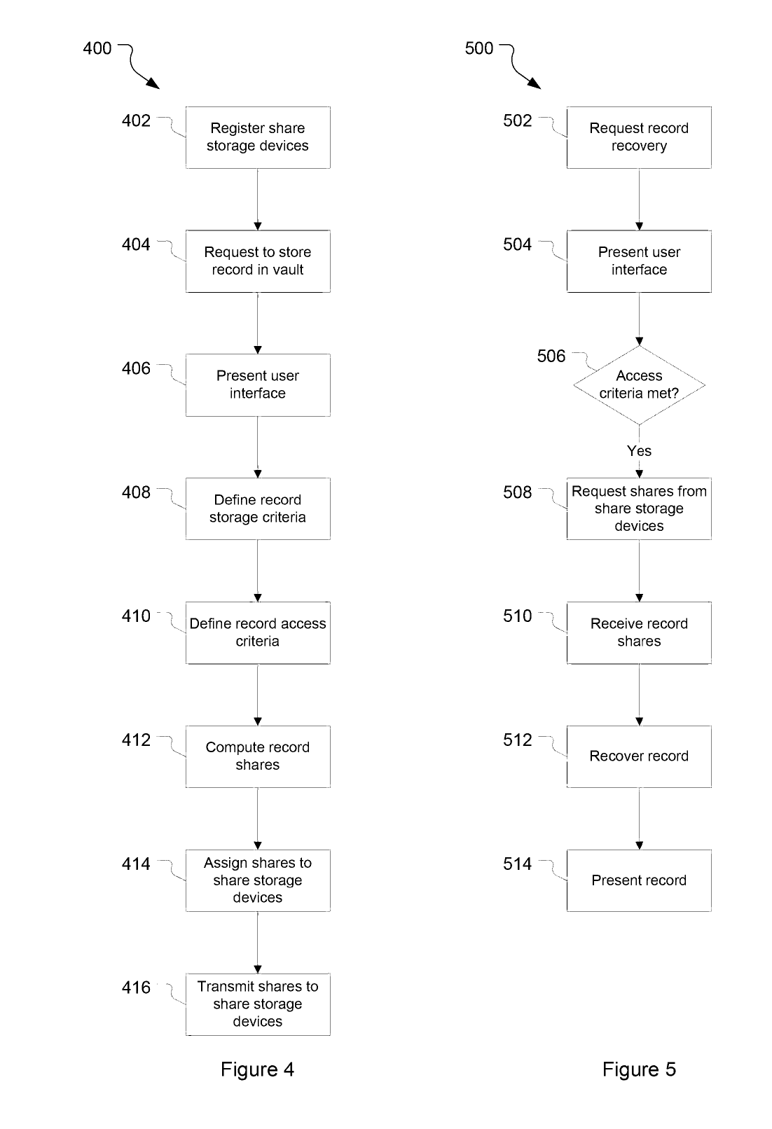

FIG. 4 is a flow chart 400 illustrating steps performed by the vault controller device 102 in securely storing a record in accordance with an embodiment.

At 402 share storage devices 104 that may take part in sharing records kept in the vault are registered. These will typically be devices under control of the user but as described above may in some embodiments include devices controlled by third parties (e.g. friends/family, trusted entities, couriers, etc.). Share storage devices 104 may be registered in a variety of ways. For example, the vault controller device 102 may lead the user through a process where the user is prompted to connect the vault controller 102 to share storage devices 104. Alternatively, a user may manually enter information on intended share storage devices 104.

During the registration process the vault controller device 104 captures and stores information about each registered share storage device 104 and its qualities. Such information may include, for example: connectivity capabilities (RF, Bluetooth, WiFi, cellular network etc.); geolocation capabilities, gesture recognition capabilities, etc. Some information may be automatically captured based on the manner in which a particular share storage device 104 connects to the vault controller device 102 (e.g., by RF connection, by Bluetooth, over a networked communication channel etc.). Information may be known or retrieved where the share storage device 104 is a known type of device with known capabilities. The vault controller 102 may also allow a user to manually enter information on the capabilities of share storage devices 104.

The vault controller stores an identifier for each share storage device registered to allow for different devices to be identified, along with their capabilities, and the manner in which communications are to be made to the device.

As will be appreciated, a user need not complete step 402 each time a record is to be shared. Rather, step 402 is performed initially in order to register share storage devices 104, and a user may periodically operate the vault control program to return to 402 to add additional share storage devices 104, remove share storage devices 104, or modify the stored information regarding share storage devices 104. The vault controller device 102 itself may be a share storage device 104 (either automatically added by the vault control program or manually added by a user).

At 404 the user requests to store a record in the vault. In one embodiment, the user may be given an option to store a record recently provided by the user. For example, if the user initiates a purchase transaction and provides credit card information to complete the transaction, the user may be given the option to store the credit card information in the vault for use with future purchase transactions. Alternatively, the vault control program may provide a user interface for a record to be selected. For example, a user may select a record for secure storage by: interaction with a file explorer type interface allowing a user to navigate through a file structure to identify a record to be stored; a drag and drop type interface allowing a user to drag a record to be stored into a particular location such as a “record storage” icon; providing a menu item accessible on selection of a record to be stored, and/or by other selection means. If the user requests to store the record, the process proceeds to step 406.

At 406 a user interface is presented to the user by which the user can define record storage and access criteria in respect of the record selected at 404. In one embodiment the user interface is a configuration table as described above displayed by the vault controller to the user. The table includes a column for each registered device and a row for the record.

At 408 record storage criteria are defined. This involves the user selecting which of the registered share storage devices 104 are to be used to store shares of the record.

In one embodiment the user is prompted to optionally nominate a particular security characteristic of the record, such as “high,” “medium,” or “low.” If the user nominates a security characteristic of the record, the configuration table is populated with suggested devices appropriate for storing shares of the record based on the nominated characteristic. For example, if the record is a low security record and four share storage devices 104 are registered, it may be suggested that shares of the record be distributed among 2 of 4 available share storage devices. However, if the record is a high security record, it may be suggested that shares be distributed among all 4 share storage devices. A recommendation as to the number of share storage devices that must be present in order to recover the record may also be made. In addition, or alternatively, predefined security templates for various record types may be stored defining the number (or minimum number) of share storage devices required or recommended for permitting recovery of records of a given type and/or the number (or minimum number) of share storage devices shares of the record of that type should be distributed between. On a request being made to store a record of a known type the vault controller accesses the conditions for that record type and suggests (or enforces) the conditions associated with that record type. For example, predefined conditions for records of the type “will” may be that at least three share storage devices are necessary to recover the record and that the record should be stored between at least five devices. As a further example, a predefined condition for card verification code records may be that a share storage device controlled by the issuing bank of the card receives one or more shares, and that those shares are required in order to recover the record.

The user selects which of the registered share storage devices he or she wishes to use to store shares of the record. As part of this step the user may confirm using the share storage devices suggested based on the nominated security characteristic, or may select alternative share storage devices.

At 410 record access criteria are defined. As discussed above, various record access criteria may be defined, include (or example): defining how many share storage devices 104 are necessary to recover the record (e.g. a minimum number of share storage devices); that one or more share storage devices 104 must be present in order to recover the record; that one share storage device 104 must be tethered to another share storage device 104 in order to recover the record; that a share storage device 104 can only be used to recover the record during a certain time period; that a share storage device must be at a particular geographical location in order to recover the record; that a particular gesture must be performed with a share storage device 104 to access the record; and/or other access criteria.

At 412 the shares for the record are computed by the vault controller device 102 using a secret sharing algorithm (discussed below).

Once the shares for the record have been generated (at 412) the original record can be deleted. In one embodiment this may be done automatically. In an alternative embodiment the vault controller program may prompt the user asking whether or not the original record should be deleted and, if the user indicates it should, deleting the record.

At 414, the computed shares are assigned by the vault controller device 102 to each of the selected share storage devices 104.

At 416 the computed shares are transmitted by the vault controller device 102 to the selected respective share storage devices 104. During the sharing if it is not possible to communicate with a selected share storage device 104 (e.g., the selected device is a Wi-Fi device and located in an area without a Wi-Fi network), the user is prompted that shares cannot be stored at that time at the unavailable share storage device 104. The user is reminded to make the device available for distributing shares to the device. When the unavailable share storage device 104 becomes available (i.e., it is possible to communicate with the device), the respective shares are transmitted to the share storage device 104 for storage.

In some embodiments, and depending on the record access criteria defined and the capabilities of a given share storage device 104, the vault control device 102 may additionally transmit access criteria applicable to the record share to the share storage device 104. For example, if access criteria for a record define that a gesture must be made with a particular share storage device 104 in order to recover the record, then the vault control device will communicate this requirement to that share storage device 104. The share storage device 104 can then implement the requirement—e.g. so that the share storage device 104 will not actually transmit the record share to the vault controller device 102 unless the requisite gesture is made.

In one embodiment, the vault controller program described herein may be operated on a server system remote from the device being operated by the user (the user's device). The remote server system communicates with the user's device via one or more networks. In another embodiment, the vault controller is operating on the user's device.

Recovering a Record

Below are steps of a process for accessing/recovering a stored record according to one embodiment. Those of skill in the art will recognize that other embodiments can perform the steps below in different orders. Moreover, other embodiments can include different and/or additional steps than the ones described below.

FIG. 5 is a flow chart 500 illustrating steps performed by the vault controller device 102 in recovering a securely stored record in accordance with an embodiment.

At 502 the user requests from the vault controller device 102 to access a stored record. For example, the user may request that previously stored credit card information be retrieved. In one embodiment retrieval of stored credit card information may be for the purposes of automatically filling a form (e.g., a purchase transaction form requesting information to complete a purchase transaction) that includes fields for entering credit card information.

At 504 an interface is presented to the user that reminds the user of which share storage devices 104 were previously selected for sharing so that the user may bring a necessary subset M together for recovery.

In other embodiments the user is not reminded of which share storage devices 104 the user originally selected to store the record. Instead the user must remember which share storage devices 104 were selected. This provides an extra level of security since an attacker (i.e., a user unauthorized to access the record) would have to determine on his own which share storage devices are required to access the record.

The share storage devices 104 required to recover the record are brought together/enabled by the user and/or activated if necessary so that they can communicate with the vault controller device 102. Some share storage devices 104 may require a passcode to be provided. Some share storage devices 104 may be remote computers to which the user must log on.

At 506 the vault controller determines whether the access criteria are met. This involves determining whether the required share storage devices are accessible. In addition, if security conditions to access the record were set, the vault controller device 102 also verifies that the set security conditions are met (e.g., two devices have established a tether or a device is at a particular geographical location).

Some record access criteria (e.g. share storage device specific conditions) may be enforced by the vault controller 102 and/or the share storage devices 104 themselves. The broad difference between enforcement methods is that if record access criteria are enforced by the vault controller 102 the vault controller 102 will receive relevant record shares from share storage devices 104 but is configured not to permit recovery of the record unless the relevant criteria are met. In contrast, if criteria are enforced by a share storage device 104 then the share storage device 104 is configured not to transmit its record share(s) to the vault controller 102 unless the conditions are met (preventing the vault controller 102 from recovering the record irrespective of programming).

For example, if access criteria for a record define that a gesture must be made with one of the share storage devices in order to recover the record, then the share storage device 104 may be configured so that it will not actually transmit the record share to the vault controller device 102 (despite receiving a request from the vault controller 102) unless the requisite gesture is made. In this case actually receiving the share from the share storage device is indication that the access criteria have been satisfied. Alternatively, the share storage device 104 may be configured to transmit the record share to the vault controller 102 on a request being made irrespective of whether the required gesture is made. In this case the vault controller 102 will received the share, but is configured not to recover the record unless a transmission from the share storage device 102 indicating that the required gesture is made is also received. As another example, a location requirement in respect of a share storage device 104 may be enforced by the share storage device 104 itself (the share storage device 104 being configured such that it will not transmit a record share unless it is in the specified location) and/or by the vault controller 102 (the vault controller 102 receiving the share from the share storage device 104 irrespective of its location, but being configured to only permit recovery of the record if it also receives a communication from the share storage device 104 indicating the device 104 is in the required location).

At 508, once the required share storage devices 104 are able to communicate with the vault controller and applicable security conditions are satisfied, the vault controller device 102 requests from the share storage devices 104 the shares of the record requested.

At 510 the vault controller device 102 receives the requested shares from the share storage devices 104.

At 512 the vault controller device 102 invokes a record recovery algorithm to recover/compute the original record from the received shares (discussed further below).

At 514 the recovered record is presented to the user. For example, if the record is credit card information, the credit card information may automatically be entered into fields of a form requesting credit card information.

If the record access criteria are not met at 506 the process may either delay until the criteria are met or end (in which case a further request for the record can be made).

### General Implementation Example

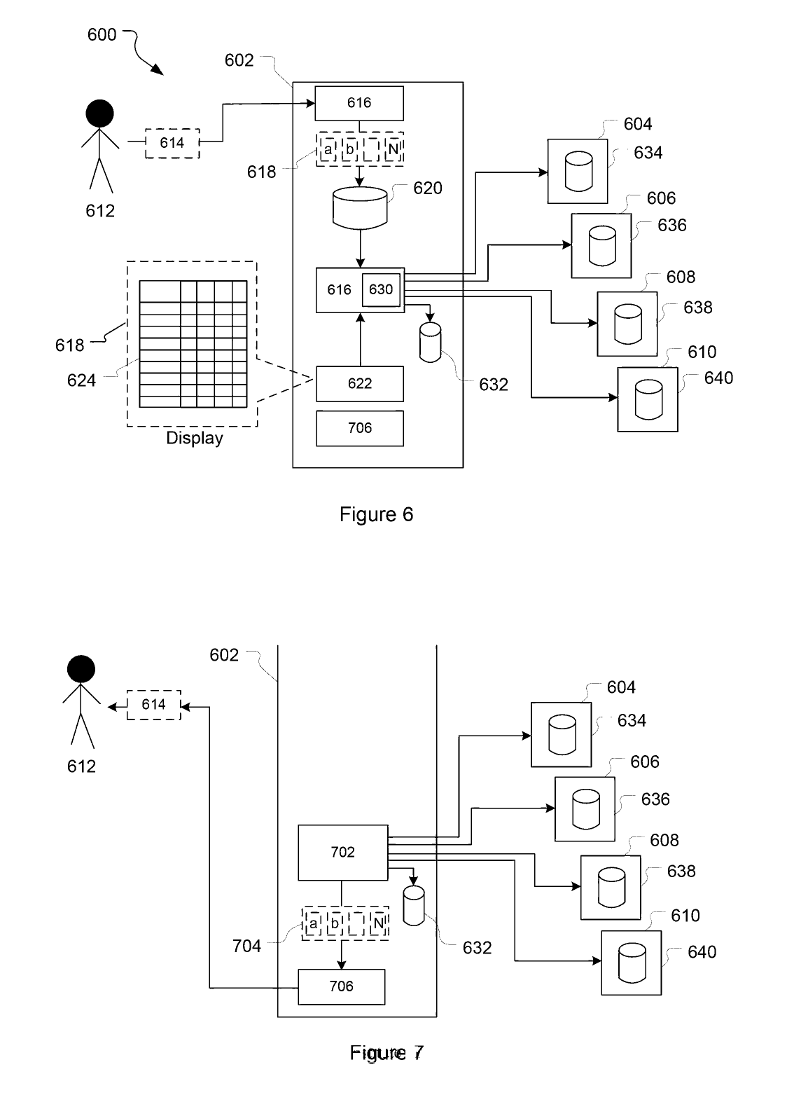

FIGS. 6 and 7 depict an example implementation 600. FIG. 6 depicts storage of a record and FIG. 7 depicts recovery of a record. In the example implementation of FIGS. 6 and 7 the vault is implemented across a mobile computer 602, a mobile phone 604, a smart card 606, a key fob 608 and a remote computer 610 in the cloud (may also be referred to as cloud device 610).

In this embodiment, the vault shares storage of a record across five share storage devices 104: the mobile computer 602, the mobile phone 604, the smart card 606, the key fob 608 and the remote computer 610. The vault is controlled from mobile computer 600 (the mobile computer therefore acting as both the share controller device 102 and a share storage device 104).

As shown in FIG. 6, the user 612 provides a record 614 to the mobile computer 602 (by user interface and data entry means not shown in the interests of simplicity). The record 614 forms an input to a secret sharing algorithm module 616. Based on the record storage and access criteria defined (per the configuration discussed below) the sharing algorithm module 616 generates a share vector 618 comprising shares numbered (a) through (N) and saves said share vector in a cache 620.

Once record shares in respect of the original record 614 have been created the original record 614 can be deleted/removed from memory.

A configuration module 622 provides the user with a configuration table 624 and means for selecting which share storage devices the record is to be distributed between (in this case all five share storage devices 602, 604, 606, 608 and 610), the number of devices that need to be present in order to recover the record, and if there are any specific share storage devices required to recover the record 614. The configuration table information is used by the sharing algorithm module 616 to generate the shares in respect of the record 614.

The user 612 views the configuration table 624 via a display 626 controlled by the vault controller device 102 (i.e. computer 602). The configuration table 624 allows the user to select which of the separate share storage devices is to be included in the set M that when activated permit access to the record 614. In this embodiment, the configuration table is organized row-wise by record to be stored in the vault, and for each record provides check boxes indicating the available share storage devices 104. In one embodiment the user checks a box in the row for each share storage device the user wishes to be involved in storing the record concerned. Through the configuration table 624 the user is also able to set up security conditions as described above. In another embodiment the configuration table may be pre-populated with suggestions (or requirements) as to storage and/or access criteria based, for example, on the type of the record being stored.

The distribution of record shares to share storage devices 104 is controlled by a distribution module 628. It is not necessary for all devices to be present at the same time for distribution. The distribution module 628 contains a state machine 630 which responds when a required share storage device can be communicated with (e.g. by being within range for direct communications such as Bluetooth or is accessible via a network) and keeps track of which share storage devices have received their respective record shares. When all record shares have been loaded to the intended share storage devices a flag is set in the state machine 630 to indicate that the vault is now holding the record—i.e. that the record has been securely stored.

Once a record share has been successfully transmitted to its share storage device it is deleted from the cache 620.

When a share storage device 104 receives a record share it is stored on a memory device: e.g.—e.g. for mobile computer 602 the record share(s) is/are stored in memory 632, for the mobile phone 604 the record share(s) is/are stored in memory 634, for the smart card 606 the record share(s) is/are stored in memory 636, for the key fob 608 the record share(s) is/are stored in memory 638, and for remote computer 610 the record share(s) is/are stored in memory 640. If the share storage device 104 is responsible for any access criteria (e.g. a required gesture or the like) this information is also received by the share storage device 104 and saved/implemented.

Referring to FIG. 7, to recover a record, computer 600 running vault control software with its record of the share storage devices 104 in state machine 630 prompts the user that a certain subset or number of M share storage devices (from the set 602, 604, 606, 608 and 610) need to be activated to communicate with the vault controller computer 602. Activation may be automatic once a share storage device 104 is accessible. For example, where communication with a share storage device is by RF (e.g. in the case of the mobile phone 604 and/or the smart card 606) activation/access may be automatic when the share storage device is within range of the vault controller computer 600. In some cases, activation may require logging on separately, for example, to the remote computer 610. Activation might further require entry of a passcode to activate a share storage device like the mobile phone 604. Once the M share storage devices concerned are so activated and communicating with the vault controller computer 602, recovery module 702 operates to retrieve the necessary record shares from the share storage devices, assembles the record shares in a recovery vector 704, and sends said recovery vector to a message recovery module 706. A secret sharing algorithm recovery process (discussed below) is executed by the recovery module 706 to recover the record from the shares. The recovered record 614 is then presented to the user (e.g. by being displayed on display 626).

In one embodiment, if a user wishes to store a large record but evenly sized shares would exceed the capacity of some of the devices (e.g. the smart card 300), an alternative approach may be adopted. In this case the process involves encrypting the record and storing the encrypted record in a desired location accessible by the user (e.g. remote computer 610). The encryption key (which is relatively small) is then treated as the record to be securely stored—i.e. processed and shared among a number of share storage devices each with relatively small capacity such as mobile phone 604 and smart card 606. Recovery of the original record is then a two-step process wherein first the encryption key record is recovered from share storage devices (604 and 606 in this case), and second the encryption key is used to decrypt the record.

To further increase security the encrypted record can itself be stored as a secure record—i.e. by calculating a number of shares and storing those shares amongst a plurality of share storage devices. If the record is large in size the share storage devices will need to have sufficient memory to store the required share(s). Furthermore, the set of share storage devices used to store the encrypted record may be a different set of share storage devices used to store the key required to decrypt record.

More generally, storage of a file using this methodology involves: encrypting the file; securely storing the encrypted file as a record by defining record storage and access criteria for the encrypted file and generating/distributing shares accordingly; and securely storing the encryption key as a record by defining record storage and access criteria for the encryption key and generating/distributing shares accordingly. Recovering the file is then achieved by recovering the encrypted file record, recovering the encryption key record, and decrypting the encrypted file using the encryption key. This process may be used with small or large files.

The secure storage of sensitive data across multiple devices, as described above, can be applied to solve the problem of secure management of credit card verification codes, known variously as card verification values (CVV, CVV2), card verification codes (CVC, CVC2), card security codes (CSC), card verification data (CVD), card verification numbers (CVN), card verification value codes (CVVC), verification codes (V-code or V code), card code verifications (CCV) etc. In this description the term CVV is used as a general term to refer to a code (e.g., three or four digit security code) typically printed on a credit card and used as an adjunct to the main “Primary Account Number” (PAN) in order to prove at the time of a transaction, control of the card by its rightful cardholder. Hence, any processes described herein as being performed with a CVV can be applied to any code, such as a CVC2 and a CVV2.

Payment Card Industry (PCI) data security standards generally forbid the storage of CVVs even if encrypted. Also the CVV is too sensitive to send via API calls with PANs and other customer data. However, the digital vault described above applies a novel alternative for securely storing a CVV amongst memory elements in multiple share storage devices 104.

With the use of the digital vault described above it is impossible for an attacker to retrieve the CVV from any individual component in the system. The CVV can only be retrieved (and presented to a merchant) when the required number of shares of the CVV record are available. This, in turn, requires that the necessary share storage devices are present and accessible and that any imposed security conditions for recovery of the record are complied with. As discussed further below, a feature of the secret sharing algorithms used is that unless the requisite number of record shares are available no information in respect of the plaintext record (e.g. the CVV) is ascertainable. That is, if m record shares are necessary for recovery, then any number of shares less than m do not allow for recovery of the record. Furthermore, having a number of shares less than m does not increase the possibility of guessing/recovering the record than if no shares are present. An attacker who accesses one share or any subset of shares numbering less than m has no information about the plaintext, and is therefore in no better position to predict the plaintext than they would by pure guesswork. In contrast, conventional encryption (as forbidden for storing CVVs by the PCI rules) does provides some information to an attacker by way of the cyphertext, for given the cyphertext, an attacker can attempt to mount a brute force attack.

The secret sharing method (the method described above regarding storing shares of a record among multiple devices) therefore does not truly constitute “storage” nor encryption of the CVV. Instead, the secret sharing method represents a more fundamentally robust way of securing the CVV in electronic storage devices, in a way that does not violate the PCI rules.

Furthermore, by utilizing multiple share storage devices 104, the secret vault is able to ensure that a diverse range of communication methods/channels is used for later retrieving these components and recovering the record (e.g. direct communications via a Bluetooth/RF communications channel, networked communications via a network communications channel). This prevents a single attack on any communication mechanism from ever yielding all the required parts to re-assemble the CVV.

In typical card payments system, the CVV appears briefly as the cardholder manually keys in the CVV digits. In an application of the present embodiment, however, instead of re-entering the CVV manually the vault controller device recovers the CVV fleetingly before deleting it once more. In one embodiment, the vault controller device takes steps to mask the CVV with asterisks when the CVV is automatically entered into a required CVV field. This method is more secure than the cardholder taking out their card every time they shop and entering the CVV afresh.

In one embodiment the digital vault is part of a system which if offered by a bank or other financial institution to its customers to facilitate their use of e-commerce and mobile commerce. The system is focused on making online transactions simple and secure for consumers. Transactions are simplified by having data to register a user or complete a transaction automatically filled into fields of a page (e.g., a web page). The transaction is made secure by using the methods described herein to securely store and retrieve sensitive data used in such e-commerce transactions.

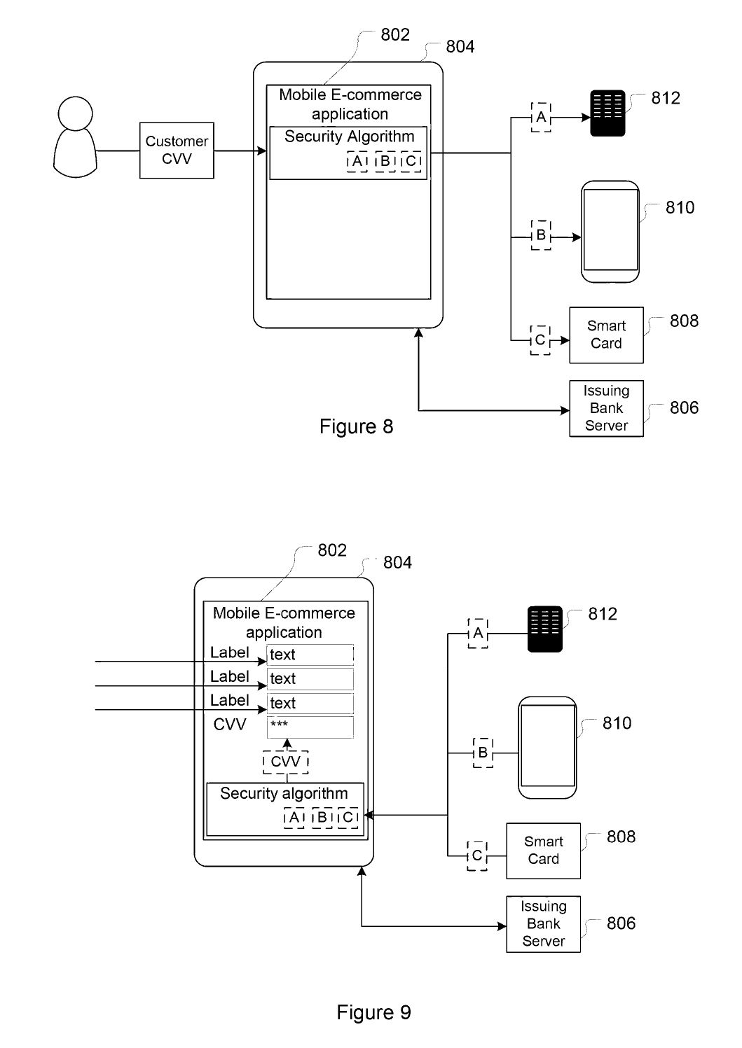

Components of an example system 800 are shown in FIGS. 8 and 9. These comprise:
A Mobile E-commerce Application 802: The application 802 is a go-between for all of the various services. At checkout of an e-commerce transaction, the e-commerce application 802 acts to automatically assemble (form-fill) in real-time data for the transaction before passing the data directly to a merchant's server. Application 802 is depicted as running on a tablet 804, but may run on any other computer processing system or device which is being used by a user to perform an e-commerce transaction. With respect to a secured data such as CVV which cannot be stored in any single device, the application 802 reassembles the record shares of the secured data from the share storage devices over which it is shared. In one embodiment, the application 802 also needs to establish a connection with issuing bank's server 806 regardless of whether the issuing bank's server 806 holds a share of the secured data. The connection provides the issuing bank with a means of authenticating the user and/or any of the devices and ultimately authorizing any transaction. In one embodiment, the connection is secured using HTTPS. Application 802 also includes the functionality of the vault controller program discussed above.
Smart card 808: The card 808 must be activated and detected by the application 802 in order to enable any actions, thus creating multi-factor authentication. In one embodiment, the card 808 is also share storage device storing a share of the cardholder authorization data (e.g. CVV). This renders a complete form-filling action impossible until the card 808, the application 802 and the issuing bank server 806 are connected and mutually authenticated. In one embodiment, the card 808 is inactive, in a “sleep” mode, unless a particular gesture is performed with card 808 that is detected by sensors on the card 808. An example of a gesture includes the card 808 being “tapped” to wake into an active mode, at which point it makes its share of the secured data accessible/transmits its share. In an alternative embodiment, as an additional security measure, the card 808 may also contain a light sensor, or a numeric keypad for entering a passcode; either of these mechanisms may be used to place the card 808 in an active state (e.g. by requiring the light sensor to be detecting light and/or requiring entry of a passcode to be active).
Examples of other share storage devices over which the secured data is shared may include a mobile phone 810, a remote server 812, or any other appropriate share storage device.
Issuing Bank Server 806: The issuing bank server 806 is an endpoint associated with the issuing bank which can be reached by the application 802, for example, for obtaining cardholder details and a part of the cardholder authorization data prior to checkout.

FIG. 8 shows a first data flow relating to a user enrolling a credit card and providing a CVV of the credit card. The application 802 receives the CVV as a record and generates a number of CVV record shares. In this example, three shares are created A, B, and C. The application 802 transfers the created shares to share storage devices for storage. In one embodiment, the user selects among which devices the CVV record shares will be stored as described above. In another embodiment, the application 802 automatically selects amongst which devices the CVV record shares will be stored. In this example, share A is stored by the remote server 812, share B is stored by the mobile phone 810, and share C is stored by the smart card 808.

FIG. 9 shows a second data flow relating to when the CVV is needed, for example to facilitate an e-commerce transaction. In this case the application 802 fetches the shares and reassembles the CVV using the fetched shares. In one embodiment, each of the share storage devices amongst which the CVV was stored is required to provide its CVV share in order to be able to reassemble the CVV. In another embodiment, only a subset of the share storage devices needs to provide their respective CVV share in order to reassemble the CVV. In the example of FIG. 5, the application 802 reassembles the CVV using share A received from the remote server 812, share B from the mobile phone 810, and share C from the smart card 808.

In one embodiment, the application 802 reassembles the cardholder CVV on the mobile computer 804 (just as though the user entered the CVV manually) at the very last moment before transmitting all cardholder and purchase details (along with the CVV) to a merchant server with whom an e-commerce transaction is being conducted. In one embodiment, the application 802 uses the HTML input type “Password” for the reassembled CVV causing it to be displayed on the mobile computer 804 as asterisks so the actual digits of the CVV are not displayed. This prevents shoulder-surfing whereby someone looking over the shoulder of the consumer can record the CVV. Because the CVV is not entered manually when engaging in an e-commerce transaction, this system is safer than having a shopper use their card in a normal CNP (card not present) online shopping transaction.

The reassembled CVV temporarily exists in memory of the mobile computer 804 on which the e-commerce transaction is taking place. The shares and the reassembled CVV are purged from memory, for example, once the CVV is transmitted to the merchant server or the transaction is complete.

In another embodiment, one or more shares of a user's sensitive payment information records (e.g., credit card number, CVV, billing address, etc.) are stored by the issuing bank server 806, and the scheme is implemented such that the share(s) stored by the bank server 806 are necessary to recover the record(s). This effectively gives the bank a real time “casting vote” on any transaction. The bank can block an attempted payment if there is reason to suspect compromise of the cardholder's information.

In a further embodiment, the credit or other payment card to which the verification code relates is itself a smart card. In this case the record storage and access criteria may define that the credit/payment card is one of the share storage devices for the CVV record and is a share storage device that is required in order to recover the CVV record. This effectively enforces a card present transaction as the CVV for the card cannot be recovered from the vault without the card being present and the record share(s) stored by the card being obtained.

Secret Sharing where all Devices are Required

Where record storage and access criteria define a scenario in which a given record is to be divided up into n shares and all n shares are required to recover the record (i.e. a m of n scheme where m=n) a split-knowledge sharing scheme may be implemented.

In order to securely store a record the vault controller device 102 converts the record to a binary number r. This can be achieved in a variety of known ways (e.g. by reference to ascii values of the letters/numbers/symbols defining the record).

Vault controller device 102 also determines the number of shares n that need to be generated based on the record storage and access criteria. E.g. if the user defines that the record is to be stored among three share storage devices then n=3 shares will need to be generated.

Vault controller device 102 generates shares x₁ to xₙ as follows.

The vault controller device 102 generates the first n−1 record shares as random binary strings x₁ to xₙ₋₁. Each random string xₙ being the same length (i.e. number of bits) as the length of the record r.

The vault controller device 102 generates share n to be:

Share n=r⊕x₁⊕ . . . ⊕xₙ₋₁
(⊕ indicating a bit-wise XOR operation.)

Each generated share is then distributed to the relevant share storage device(s) 104.

In order to recover the record the vault controller device 102 retrieves each of the shares x₁ to xₙ from the relevant share storage device(s) 104 and recovers the record according to the following calculation:

r=x₁⊕x₂⊕ . . . ⊕xₙ

Shamir Secret Sharing

In another embodiment, the digital vault protects records using the techniques of Shamir Secret Sharing as initially described in: Adi Shamir. How to share a secret. Communications of the ACM, 22(11):612-613, November 1979.

In this embodiment the vault controller device 102 is configured to generate shares of a record and to recover a record based on generated shares according to Shamir's secret sharing techniques. Using these techniques a user can define a sharing scheme in which n shares of a record are generated and distributed between share storage devices 104, but only m shares are necessary in order to recover the record (m being less than or equal to n).

In this embodiment the vault controller device 102 determines the total number of shares n that need to be generated and the number of shares m that need to be present for recovery of a record r based on the record storage and access criteria.

The vault controller device 102 determines a field Fₚ in which the secret sharing scheme operates. The field Fₚ comprises the integers 0 to p−1, where p is a prime number greater than n and greater than r (when record r is presented as an integer value).

The vault controller device 102 arbitrarily selects n distinct non-zero elements, x₁ to xₙ, from the field Fₚ.

The vault controller device 102 randomly selects m−1 distinct non-zero elements, ƒ₁ to ƒₘ₋₁, from the field Fₚ. Elements ƒ₁ to ƒₘ₋₁ are kept secret.

The vault controller device 102 computes the n shares (y₁ to yₙ) according to:

yᵢ=ƒ(xᵢ)

Where:

$$f ( x ) = r + {\sum }_{j = 1}^{m - 1} {f}_{j} {x}^{j} mod p$$

The vault controller device 102 then distributes both the share y and the associated arbitrarily selected element x to the relevant share storage device(s). I.e. share i is distributed as (xᵢ, yᵢ).

In order to recover the record, the vault controller device 102 gathers at least m shares from the share storage devices. From the m shares the record is calculated as:

$$r = {\sum }_{i = 1}^{m} {c}_{i} {y}_{i} mod p$$

Where:

$${c}_{i} = {\prod }_{i \leq j \leq m , j \neq 1} \frac{{x}_{j}}{{x}_{j} - {x}_{i}} mod p$$

Requiring Specific Devices for Recovering a Record

As described above, in certain embodiments access criteria may be set such that one or more particular shares must be obtained (or one or more particular share storage devices 104 must be present) in order to recover a record.

This may be achieved in a number of ways.

For example, requiring the presence of one or more particular share storage devices may be achieved by programming of the vault controller program running on the vault controller device 102. In this case the vault controller device 102 is programmed such that if the access criteria require a particular share storage device 104 to be present to recover a record the vault controller device 102 will not permit recovery of the record unless that particular share storage device 104 is present.

Alternatively, the requirement for one or more particular share storage devices to be present may be imposed by the secret sharing algorithm itself—specifically by the number of record shares created and how those record shares are distributed between the share storage devices 104. In the context of Shamir's secret sharing, a scheme which requires a particular participant (i.e. share storage device 104) to be present to recover a record is referred to as a monotone access structure.

For example, a user may set record storage criteria defining a record is to be stored between three share storage devices—device A, device B, and device C. The user may set record access criteria defining that two devices must be present in order to recover the record, and that one of those devices must be device A (i.e. so that devices A and B together allow for recovery of the record, devices A and C together allow for recovery of the record, but devices B and C together do not allow for recovery of the record). One way to achieve this is to generate four shares for the record (n=4) and set a rule that three shares are required to recover the record (m=3). Two of the four shares are distributed to share storage device A, one share to share storage device B, and one share to share storage device C. This is depicted in Table 7 below (a, b, c, and d representing shares in respect of the record):

TABLE 7

| Device | A | B | C |
|---|---|---|---|
| Shares | a, b | c | d |

As can be seen, no single share storage device has sufficient shares to recover the record (all devices storing less than 3 shares). Furthermore, share storage devices B and C together only yields 2 shares—which is still less than m (which in this case is 3) and therefore does not permit recovery of the record. However, share storage devices A and B together provide 3 shares (permitting recovery of the record), as do share storage devices A and C together.

As a further example, a user may set record storage criteria defining a record is to be stored between five share storage devices—device A, device B, device C, device D, and device E. The user may set record access criteria defining that three devices must be present in order to recover the record, and that in order to recover the record share storage devices A and E must be present. One way to achieve this is to generate 9 shares for the record (n=9) and the rule is set that seven shares are required to recover the record (m=7). Three of the nine shares are distributed to share storage device A, three shares are distributed to share storage device E, one share to share storage device B, one share to share storage device C, and one share to share storage device D. This is depicted in Table 8 below (a, b, c, d, e, f, g, h, and i representing shares in respect of the record):

TABLE 8

| Device | A | B | C | D | E |
|---|---|---|---|---|---|
| Shares | abc | d | e | f | ghi |

In this case no single share storage device or pair of share storage devices provides sufficient shares to recover the record. The most shares that can be obtained from two devices is six shares (if devices A and E are accessed), so at least three devices are necessary in order to recover the record. Any three or more devices that do not include both devices A and E, however, will yield less than the required 7 shares (e.g. devices A, B, C, and D together yield only 6 shares). Any set of three or more share storage devices that does include either device A or device E, however, will yield the required 7 shares and allow for recovery of the record.

In this example, required share storage devices (i.e. share storage devices that are defined by the record access criteria to be necessary for recovery of the record) receive more record shares than share storage devices that are not required.

In some instances (and depending on the specific access criteria) a further alternative way of implementing a security condition requiring one or more particular share storage devices to be present is to provide share storage devices that are not essential with copies of the same share or shares. For example, the criteria discussed in respect of Table 7 were that: a record is to be stored between three share storage devices (A, B, and C), at least two share storage devices must be present in order to recover the record, and one of those devices must be device A. These criteria may be implemented by a two-of-two scheme: i.e. generating two distinct shares (n=2) and requiring both shares to recover the record (n=2). One of the shares is distributed to device A, and devices B and C are both given a copy of the same share—for example as shown in Table 9:

TABLE 9

| Device | A | B | C |
|---|---|---|---|
| Shares | a | b | b |

In this case no single share storage device can recover the record as each device has only one share. Further, share storage devices B and C together cannot recover the record as they have an identical share (i.e. between them they still effectively have a single share). Share storage devices A and B, however, have two shares and therefore can recover the record. Storage devices A and C can also recover the record.

A similar approach can be taken for the example discussed with respect to Table 8—i.e. a record to be stored between five share storage devices (A, B, C, D, and E), three share storage devices must be present in order to recover the record, and two particular share storage devices (A and E) must be present to recover the record. These criteria can be met by a 3 of 3 scheme with device A being given a unique share, devices B, C, and D being given a copy of the same share, and share storage device E being given a unique share. This is depicted in Table 10:

TABLE 10

| Device | A | B | C | D | E |
|---|---|---|---|---|---|
| Shares | a | b | b | b | c |

By calculating appropriate numbers of shares (n) to generate for a record, the minimum number of shares required to recover the record (m), and the distribution of the shares between share storage devices, the requirement for one or more share storage devices to be present in order to recover a record can be imposed.

In this example, at least some of the share storage devices that are not required (i.e. share storage devices that are not defined by the record access criteria to be necessary for recovery of the record) receive the same record share.

Adaptation of Shamir's secret sharing to provide a monotone access structure is described in Ed Dawson and Diane Donovan. Shamir's Scheme Says It All. In IFIP/Sec '93 Conference Proceedings, pages 91-102.

It will be appreciated that the vault and techniques described herein can be used to store and recover any type of record desired. As an example, the records that may be stored by the vault include: a will; digital currency (e.g. bitcoin); licensed digital content such as music, motion pictures, TV programs etc.; a cryptographic key; confidential corporate information; credit card information; bank account information; personal information (e.g., social security number, driver license number, etc.); user names/passwords.

As used herein, except where the context requires otherwise the term “comprise” and variations of the term, such as “comprising”, “comprises” and “comprised”, are not intended to exclude other additives, components, integers or steps.

It will be understood that the invention disclosed and defined in this specification extends to all alternative combinations of two or more of the individual features mentioned or evident from the text or drawings. All of these different combinations constitute various alternative aspects of the invention.

1. A computer implemented method comprising:
receiving record storage criteria defining a set of share storage devices to be used to store shares of the record;
receiving record access criteria defining requirements for recovering the record from share storage devices in the set of share storage devices, the record access criteria defining a minimum number of share storage devices that are required in order to recover the record;
processing the record according to the record storage criteria and the record access criteria to generate a plurality of record shares from which the record can be recovered; and
transmitting the plurality of record shares to the set of share storage devices, wherein at least one record share is transmitted to each share storage device in the set of share storage devices.

2. A computer implemented method according to claim 1, wherein the minimum number of share storage devices to recover the record is less than a number of share storage devices in the set of share storage devices.

3. A computer implemented method according to claim 1, wherein the record access criteria define one or more required share storage devices, a required share storage device being a share storage device from the set of shared storage devices that is required to recover the record.

4. A computer implemented method according to claim 3, wherein the number of record shares transmitted to a required share storage device is greater than a number of record shares that are transmitted to a share storage device that is not a required share storage device.

5. A computer implemented method according to claim 3, wherein the same record share is transmitted to two or more share storage devices that are not required share storage devices.

6. A computer implemented method according to claim 1, wherein the record access criteria define that in order to recover the record two or more of the share storage devices must be tethered to one another.

7. A computer implemented method according to claim 1, wherein the record access criteria define a recovery time condition defining one or more times at which the record can be recovered.

8. A computer implemented method according to claim 1, wherein the record access criteria define one or more specific device conditions that must be met in order to recover the record, each specific device condition relating to a specific share storage device.

9. A computer implemented method according to claim 8, wherein specific device conditions are selected from a group comprising: a location that a share storage device must be in in order to recover the record; a gesture that must be made with a share storage device in order to recover the record; an input that must be made at a share storage device in order to recover the record.

10. A computer implemented method according to claim 1, wherein the record is a credit card verification code.

11. A computer implemented method according to claim 1, wherein processing the record to generate a plurality of record shares involves processing in accordance with a secret sharing algorithm.

12. A computer implemented method according to claim 11, wherein the secret sharing algorithm is derived from the Shamir secret sharing algorithm.

13. A computer implemented method according to any claim 1, the method further comprising:
requesting record shares from a plurality of share storage devices from the set of share storage devices used to store the record;
receiving record shares in response to said requesting;
processing the received record shares to recover the record, wherein
recovery of the record is only possible if requirements defined by the record access criteria are satisfied.

14. A computer implemented method according to claim 13, wherein record shares are received from all share storage devices in the set of share storage devices used to store the record.

15. A computer implemented method according to claim 13, wherein record shares are not received from all of the share storage devices in the set of share storage devices used to store the record, and wherein the shares received permit for recovery of the record.

16. A computer processing system comprising:
a processor;
a communications interface for communicating with a plurality of share storage devices;
non-transient memory storing instructions which, when executed by the processor, cause the system to:
receive record storage criteria defining a set of share storage devices to be used to store shares of the record;
receive record access criteria defining requirements for recovering the record from share storage devices in the set of share storage devices, the record access criteria defining a minimum number of share storage devices that are required in order to recover the record;
process the record according to the record storage criteria and the record access criteria to generate a plurality of record shares from which the record can be recovered; and
transmit, via the communications interface, the plurality of record shares to the set of share storage devices, wherein at least one record share is transmitted to each share storage device in the set of share storage devices.

17. A computer processing system according to claim 16, wherein the minimum number of share storage devices to recover the record is less than a number of share storage devices in the set of share storage devices.

18. A computer processing system according to claim 16, wherein the record access criteria define one or more required share storage devices, a required share storage device being a share storage device from the set of shared storage devices that is required to recover the record.

19. A computer processing system according to claim 18, wherein the number of record shares transmitted to a required share storage device is greater than a number of record shares that are transmitted to a share storage device that is not a required share storage device.

20. A computer processing system according to claim 18, wherein the same record share is transmitted to two or more share storage devices that are not required share storage devices.

21. A computer processing system according to claim 16, wherein the record access criteria define that in order to recover the record two or more of the share storage devices must be tethered to one another.

22. A computer processing system according to claim 16, wherein the record access criteria define a recovery time condition defining one or more times at which the record can be recovered.

23. A computer processing system according to claim 17, wherein the record access criteria define one or more specific device conditions that must be met in order to recover the record, each specific device condition relating to a specific share storage device.

24. A computer processing system according to claim 23, wherein specific device conditions are selected from a group comprising: a location that a share storage device must be in in order to recover the record; a gesture that must be made with a share storage device in order to recover the record; an input that must be made at a share storage device in order to recover the record.

25. A computer processing system according to claim 16, wherein the record is a credit card verification code.

26. A computer processing system according to claim 16, wherein processing the record to generate a plurality of record shares involves processing in accordance with a secret sharing algorithm.

27. A computer processing system according to claim 26, wherein the secret sharing algorithm is derived from the Shamir secret sharing algorithm.

28. A computer processing system according to claim 16, wherein the instructions, when executed by the processor, further cause the system to:
request record shares from a plurality of share storage devices from the set of share storage devices;
receive record shares in response to said requesting;
process the received record shares to recover the record, and wherein
recovery of the record is only possible if requirements defined by the record access criteria are satisfied.

29. A computer processing system according to claim 28, wherein record shares are received from all share storage devices in the set of share storage devices used to store the record.

30. A computer processing system according to claim 28, wherein record shares are not received from all of the share storage devices in the set of share storage devices used to store the record, and wherein the shares received permit for recovery of the record.
